(19) United States
(12) Patent Application Publication
(10) Pub. No.: US 2002/0129883 A1
(43) Pub. Date: Sep. 19, 2002

(54) Solid rubber tire with cellular foam rubber region

(76) Inventor: Bernard J. O'Coin, Oakville (CA)

Correspondence Address: SHLESINGR, ARKWRIGHT & GARVEY LLP, PATENT, TRADEMARK & COPYRIGHT LAW, 3000 SOUTH EADS STREET, ARLINGTON, VA, 22202, US

(21) Appl. No.: 10/050,036

(22) Filed: Jan. 17, 2002

Related U.S. Application Data
(60) Provisional application No. 60/261,821, filed on Jan. 17, 2001.

(51) Int. Cl. B60C 11/00

(52) U.S. Cl. 152/244; 152/301; 152/246; 152/267

(57) ABSTRACT

A tire includes a tread region, a rim region, and a further region between the tread region and the rim region. The further region may include a foamed rubber. The foamed rubber may be one of cellular rubber or closed cell cellular rubber. The tire having further regions made of closed cell cellular rubber may be made as an integral solid rubber tire in a mold, such as a split mold in a one-step process. The tire may likewise be made in a multi-step process by molding each of the tread, rim, and further regions as distinct radial layers in separate molds and bonding the three separate radial layers together to form a tire having the desired characteristics.

### CROSS REFERENCE TO RELATED APPLICATION

This application claims the priority benefit of application No. 60/261,821, filed Jan. 17, 2001, which is incorporated herein by reference.

### FIELD OF THE INVENTION

This invention relates to solid tires. In particular this invention relates to solid rubber tires with cellular foam rubber center section(s), and more particularly, to solid rubber tires with high density cellular foam rubber section(s). Even more particularly, the invention relates to solid rubber tires with a closed cell cellular rubber section(s).

### BACKGROUND OF THE INVENTION

Known tires include the following:

U.S. Pat. No. 991,737 to Moore;

U.S. Pat. No. 4,217,944 to Pascal;

U.S. Pat. No. 4,877,071 to Tanigawa;

U.S. Pat. No. 5,429,165 to Ichikawa;

U.S. Pat. No. 5,579,818 to Hoppenheit; and

U.S. Pat. No. 6,142,203 to Bickford

Since the invention of solid rubber tires, there have been complaints of stiff or hard riding tire characteristics. An early solution was the pneumatic tire which eliminated the hard ride; however, it was subject to punctures and flats.

Solid rubber tires have continued to be used in many industrial applications, owing to their ability to not suffer from punctures and minor cuts, etc. However, there is a common complaint among vehicle operators that solid tires are hard riding, or that there is excessive shock transmission from the solid tires to the operator and to the machine. Such shock transmission also causes damage to the vehicle components.

A known three stage solid tire construction is intended to provide a softer ride by placing softer durometer rubbers in the center section of the tire carcass, such as in ITL products sold under the names Eurosoft® and Softuff®. These tires still provide a hard ride relative to the ride provided by pneumatic tires. Additional discussion is set forth in application No. 60/261,821, filed Jan. 17, 2001, which is incorporated herein by reference. See Appendix A and FIG. 2 therein.

### OBJECTS AND SUMMARY OF THE INVENTION

An object of the invention is to provide an improved solid rubber tire, and a method of making such.

Another object of the invention is to provide a solid rubber tire which provides vehicle ride characteristics that are more like pneumatic tires than like known solid rubber tires.

A further object of the invention is to provide a rubber tire which is made in part of cellular foam rubber.

A further object of the invention is to provide a rubber tire which is made in part of closed cell cellular foam rubber.

Another object of the invention is to provide a solid rubber tire in which a portion or rim region of the tire located between a tread region and rim contacting portion or rim region of the tire is made of a foamed or cellular foam or closed cell cellular foam rubber compound.

In summary, the invention includes an improved solid rubber tire, and a method of making such.

The invention also includes a solid rubber tire which provides vehicle ride characteristics that are more like pneumatic tires than like known solid rubber tires.

The invention includes a rubber tire which is made in part of cellular foam rubber.

The invention includes a rubber tire which is made in part of closed cell cellular foam rubber.

The invention includes a solid rubber tire in which a portion of the tire located between a tread region and a rim region of the tire is made of a foamed or cellular foam or closed cell cellular foam rubber compound.

Please note that relative terms such as up, down, left, and right are for convenience only and are not intended to be limiting.

### BRIEF DESCRIPTION OF THE DRAWINGS

FIG. 1 illustrates an embodiment of a cellular center section solid tire according to the invention, shown in cross section.

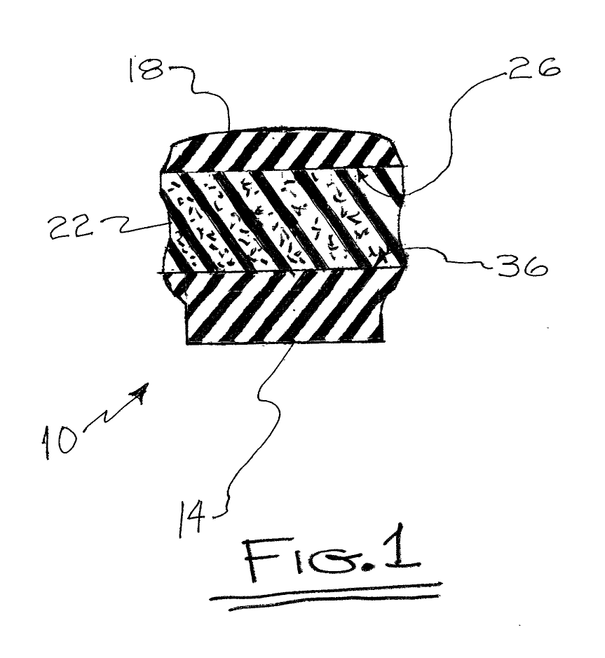

Please note that the section lines of the different regions of the tire in FIG. 1 are used to indicate three(3) different regions or “areas” or layers which may be three(3) distinct materials, the section lining of which is not intended to be limiting as to the materials used, and the section lining of which is done for convenience and ease of understanding and is not intended to be limited by the patent drafting rules set forth by the United States Patent and Trademark Office.

### DETAILED DESCRIPTION OF THE INVENTION

In FIG. 1, a tire 10 according to the invention is shown.

Tire 10 includes a rim base or rim contacting region 14. Rim region 14 may be made of solid rubber.

Tire 10 likewise may include a tread area or region or layer 18. Tread region or layer 18 may be made of rubber, such as a solid rubber.

A center section or further region 22 may be disposed between rim base 14 and tread layer 18.

Center section 22 may be made of a cellular or foam or closed cell cellular rubber material.

The three regions 14, 18, and 22 of the tire of FIG. 1 may be vulcanized as an integrally made tire. The vulcanization may be carried out in a split mold or radial section mold.

Given that center section 22 may be made of a closed cell cellular rubber material, the materials may be placed in the split mold so that the desired closed cell cellular foam characteristics of layer or further region 22 are achieved, while also creating at the same time tread region 18 of solid rubber and rim region 14 of solid rubber.

Thus, in the molding process the material will be filled into the mold so that center section 22 may expand during the vulcanization process. The expansion rate may be selected so that the closed cell cellular rubber material of region 22 expands sufficiently to fill its respective section of the mold, as well as to exert pressure on the adjacent tread region 18 material being molded and the adjacent rim region 14 being molded.

A known method of using a “green” or uncured rubber slug for molding is to make the green slug wider than the mold cavity with the green slug in the rim region being slightly larger than the corresponding rim mold diameter, while the green slug in the tread region is smaller than the corresponding tread region mold diameter. When the known green rubber slug is placed into the mold it is forced by a hydraulic press to compress in cross section and the thus compressed green rubber materials flow into the radially outer tread area and the radially inner rim area to achieve the desired compression of the respective regions of the known tire.

In the inventive method of making tire 10 having solid rubber rim region 14 and solid rubber tread region 18 with a closed celled cellular region 22 therebetween, one inventive method is to ensure that center or further region 22 not be overly compressed mechanically so as to hinder the formation of the desired closed cells in the closed cell cellular rubber material.

Thus, in the initial lay up of the green or uncured rubber material of the three regions 14, 18, and 22 in the tire mold, consideration may be given to avoid excessive back pressure from the rubber material in rim region 14 and tread region 18, which flank center region 22.

The green material laid up on the tire mold may be provided in shapes similar to the respective three mold shapes corresponding to the three regions of the tire.

This method of making tire 10 of FIG. 1 in a split mold may be termed a one piece vulcanization method, as opposed to a three piece method described below.

This one piece vulcanization may be considered a one step process.

In order to achieve a near zero porosity of rubber of solid tread region 18 for longer wear and to have a near zero porosity of the rubber of base or rim region 14, compounds to be vulcanized normally require a temperature of about 285° F+ and a mold press tonnage containment compression pressure of about 100 p.s.i. or more on the rubber surface area.

Normally, at those temperatures and pressures trapped gases and porosity in the unvulcanized rubber will be driven out.

The molding of foamed rubber may be achieved by placing a lesser quantity of material relative to a desired foam level into a fixed area mold at atmospheric pressure. Upon heating, the blowing agents or gaseous material expand causing the green or starting material to fill the mold. The strength and amount of gaseous material used may be selected to be sufficient to overcome the surrounding viscosity strength of the rubber polymer mix at the elevated molding temperatures and at atmospheric pressure.

Upon understanding these basic principles one can appreciate the need to develop and select a heat sensitive gaseous material for use in the cellular center region 22 that can develop higher than atmospheric pressure and as much as in the about 100 p.s.i. or more range. Also, these gaseous materials or blowing agents may be selected so that they will not create such an excess volume that they cause delaminating of the rubber from the tread and rim base layers.

During the manufacturing process of the tires mold vent holes may be sized and located that allow trapped air or gases to escape, allowing a quantity of unvulcanized rubber to be forced to flow out of the mold. Vent hole size and location will be considered relative to the mold size and mold configuration when vulcanizing cellular rubber compounds used in the manufacture of tires according to the invention so as to achieve the desired characteristics of the resultant tire.

The uncured rubber may be laid up in the split mold in a some what conventional manner.

Basically, in a known fashion, the solid rubber material having the desired characteristics for gripping the vehicle rim will be wrapped around in the rim region of the female side of the split mold.

Then, the green rubber having the blowing agent (s) therein for producing the closed cell cellular rubber in the center region 22 will be wrapped around the previously wrapped rubber material of the rim region in a sufficient quantity to provide the desired size and volume and closed cell characteristics, for example, of the cured closed cell rubber of center region 22.

Finally, the uncured tread rubber material, which may be conventional tread rubber or varied to the end user's desired characteristics, will be wrapped around the uncured rubber in the region of the mold filled with the previously wrapped center region material.

It should be noted that the material for forming the closed cell rubber in the center region may fill up a lesser percentage of the split mold than in known split mold molding processes, as discussed elsewhere, to ensure that the desired closed cell volume to overall volume ratio of center region 22 is achieved.

After the material corresponding to each of the three regions, 14, 22, and 18, have been filled into the female half of the mold, the male half of the split mold is positioned, and the tire may be cured as described elsewhere and along the lines of conventional tire curing processes.

An example of a suitable closed cell cellular foam rubber material, as described in the section entitled “Closed Cell Sponge Rubber” by C. W. Otterstedt of Exxon Chemical Co., Linden, N.J. 07036, found at pages 727, 729 in the Vanderbilt Rubber Handbook, Robert O. Babbit, ed., R. T. Vanderbilt Company, Inc., Norwalk, Conn. 06855, ©1978, is incorporated herein by reference. That section on “Closed Cell Sponge Rubber” describes known compounding ingredients that may be used in accordance with the invention for the material used in producing center region 22.

The amount of blowing agent may be varied in accordance with the tire size, load range, desired deflection characteristics and other considerations. The amount of blowing agent and undersizing of the amount of green rubber placed in the further or center region 22 of the tire to be molded will likewise be varied to achieve the desired operating characteristics, and percentage of closed cell structure volume to overall tire volume desired.

Example of material for region 22, set forth in above-described Vanderbilt Rubber Handbook, page 729:

Sponge, High Pressure Molded Closed
Cell, Low Cost Formulation

| | |
|---|---|
| Vistalon 5600 | 100 |
| Stearic Acid | 2.0 |
| Zinc Oxide | 5 |
| AGERITE SUPERLITE | 1 |
| Flexon 845 Oil | 70 |
| DIXIE CLAY | 80 |
| MCNAMEE CLAY | 80 |
| Whiting | 100 |
| Opex 93 | 4 |
| BIK | 2 |
| Sulfur | 2.0 |
| CAPTAX | 1 |
| METHYL TUADS | 1.47 |
| Density Mg/m³ | 1.47 |

Physical Properties, Cure: 10 Mins. @ 149° C./300° F.;
Post cure 20 Mins @ 149° C./300° F.

| | |
|---|---|
| Compression Deflection, Mpa/psi | .09/13 |
| Density, Lb. Mg/m³ | .44 |
| Water Absorption, Wt. % | >1 |

This is merely an example. The ratios of materials may be varied depending on desired characteristics, as described above. The above-mentioned BIK is a tradename for a known blowing agent.

It has been found that a rubber compound with a tensile strength of 2000 p.s.i. can be achieved with a 15% cell structure by volume weight, and it can carry a load equal to the load carried by an equivalent 100 p.s.i. pneumatic tire.

The tread and rim region materials may be conventional, such as set forth in U.S. Pat. No. 5,429,165 to Ichigawa and U.S. Pat. No. 5,579,818 to Hoppenheit, each of which is incorporated herein by reference.

One method of making tire 10 of FIG. 1 is to mold each one of the sections separately; i.e., base 14, center 22, and tread 18. Then one may buff each mating surface 26 and 36 of the respective sections 14, 18, 22, and apply rubber cements and bonding agents on surfaces 26 and 36, and then vulcanize each of the adjacent sections to each other. Three separate respective molds may be used; i.e., a rim region mold, a center region mold, and a tread region mold.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features herein before set forth, and fall within the scope of the invention or limits of the claims appended hereto.

1. A tire comprising:
a) a tread region;
b) a rim region;
c) a further region disposed between the tread region and the rim region; and
d) the further region including a foamed rubber.

2. A tire as in claim 1, wherein:
a) the foamed rubber of the further region includes a cellular rubber.

3. A tire as in claim 2, wherein:
a) the cellular rubber of the further region includes a closed cell cellular rubber.

4. A tire as in claim 3, wherein:
a) the tread region includes a substantially solid rubber.

5. A tire as in claim 4, wherein:
a) the rim region includes a substantially solid rubber.

6. A tire as in claim 2, wherein:
a) the tread region includes a substantially solid rubber.

7. A tire as in claim 6, wherein:
a) the rim region includes a substantially solid rubber.

8. A tire as in claim 1, wherein:
a) the tread region includes a substantially solid rubber.

9. A tire as in claim 8, wherein:
a) the rim region includes a substantially solid rubber.

10. A tire comprising:
a) a tread region, the tread region including rubber;
b) a rim region, the rim region including rubber;
c) a further region disposed between the tread region and the rim region; and
d) the further region including a closed cell cellular rubber.

11. A tire as in claim 10, wherein:
a) the tire includes a solid rubber tire.

12. A method of forming a solid rubber tire, comprising the steps of:
a) providing a mold of the type including a tread region, a rim region, and a further region disposed between the tread region and the rim region;
b) providing an uncured rubber in a rim region of the mold;
c) providing an uncured rubber in a further region of the mold, the uncured rubber including a blowing agent for developing closed cells in cured rubber;
d) providing an uncured rubber in the tread region of the mold; and,
e) providing a sufficient quantity of the uncured rubber including the blowing agent in the further region of the mold so that in a curing step for the uncured rubber the rubber in the further region exerts sufficient pressure for the formation of closed cells.

13. A method as in claim 12, further comprising the step of:
a) providing a vent hole in the mold.

14. A method as in claim 12, wherein:
a) in the step of providing a sufficient quantity of uncured rubber in the tread region of the mold, the quantity is selected so that its cured rubber volume is in the range of about 2-5% greater than the volume of the tread region of the mold.

15. A method of forming a tire as in claim 12, wherein:
a) in the step of providing an uncured rubber in the further region of the mold, the quantity of uncured rubber is selected so that the cured rubber of the further region includes about a 15% cell structure by volume.

16. A tire as in claim 3, wherein:
a) a cell structure of the closed cells of the closed cell cellular rubber includes about 15% of a volume of the further region.

17. A method of forming a solid rubber tire, comprising the steps of:
a) providing a tread region mold, a rim region mold, and a further region mold;
b) providing an uncured rubber in the further region mold, the uncured rubber including a blowing agent for developing closed cells in cured rubber;
c) providing an uncured rubber in the tread region; and,
d) providing an uncured rubber in the rim region mold.

18. A method as in claim 17, further comprising the steps of:
a) curing the rubber in the rim region mold, center region mold, and tread region mold; and,
b) joining the cured tread region to the cured rim region and the cured tread region.

19. A tire as in claim 3, wherein:
a) a cell structure of the closed cells of the closed cell cellular rubber includes about 15% of a volume of the further regions.
